(19) United States
(12) Patent Application Publication
(10) Pub. No.: US 2010/0242066 A1
(43) Pub. Date: Sep. 23, 2010

(54) Method of Performing Random Seek Preview for Streaming Video

(75) Inventor: Yung-Chao Tseng, Taipei County (TW)

Correspondence Address: NORTH AMERICA INTELLECTUAL PROPERTY CORPORATION, P.O. BOX 506, MERRIFIELD, VA, 22116, US

(73) Assignee: CYBERLINK CORP., Taipei Hsien (TW)

(21) Appl. No.: 12/406,975

(22) Filed: Mar. 19, 2009

(51) Int. Cl. H04N 5/445; H04N 7/173; H04N 5/45

(52) U.S. Cl. 725/38; 725/116; 725/110; 348/565; 348/E05.112

(57) ABSTRACT

To provide random seek of a preview position for streaming video, while playing a video stream, a preview position of the video stream is sought, and a preview result extracted from the video stream corresponding to the preview position is displayed while the video stream continues playing. Over the Internet, the preview position may be sent to a transmitting device, and the transmitting device may extract the preview result, then transmit the preview result simultaneously while transmitting the video stream.

### BACKGROUND OF THE INVENTION

1. Field of the Invention

The present invention relates to streaming video playback over the Internet, and more particularly, to a method of performing near real-time random seek preview during playback of a video stream.

2. Description of the Prior Art

With dramatic increases in bandwidth, server capacity, and user base, Internet websites are now able to provide platforms for sharing not only text-based articles, but also images, music, and videos. Likewise, peer-to-peer (P2P) applications are also being developed that allow for video streams to be shared in a decentralized manner over a distributed network of participating users.

Although shared video content and quality are increasing daily, one problem arises that is inherent to video streaming applications. Because video streams are delivered to the user in a sequential manner, and may be played back before the video stream is acquired in its entirety, typically most of the video stream will not be available to the user when playback begins, and will be downloaded gradually as the video stream is played back. If a user is viewing a movie for the first time, no inconvenience may be caused by this limitation, as the user will most likely not desire to skip ahead and see the conclusion without viewing intervening plot steps. However, in many cases, the user may desire to skip part of the video stream and resume playback at a position of the video stream after their current viewing position.

For example, the user may be viewing a rebroadcast of a baseball game that they already saw the first half of live. In this case, the user would probably like to skip directly to where he/she left off. However, because the video stream is delivered from the beginning of the game, the user would have to seek to the position corresponding to where he/she left off, e.g. by dragging a playback cursor to the position. Of course, playback may be stopped while the video stream is buffered starting from the position being sought. If the user did not know exactly which position would correspond most closely to where they left off, then one of two things will happen when playback resumes: 1) the user has already seen the content being played, or 2) the user skipped too far, and missed some content between where they left off and the position playback started from. For the first case, the user may decide to watch the content they have already seen before, or the user may decide to try seeking again. For the second case, the user may decide to miss the content and just keep watching from position playback started, or the user may decide to drag the cursor back a bit and seek again. Of course, each time the user performs a seek operation, the user must wait for the video stream to buffer again. Either way, the user will either miss content, or spend a long time trying to find an acceptable playback position.

### SUMMARY OF THE INVENTION

According to a first embodiment of the present invention, a method of performing random seek of a preview position for streaming video comprises playing a video stream from a server, sending the preview position of the video stream, and displaying a preview result corresponding to the preview position while playing the video stream. The server extracts the preview result from the video stream corresponding to the preview position.

According to a second embodiment of the present invention, a method of providing random seek of a preview position for streaming video comprises transmitting a video stream to a client, receiving a request including the preview position of the video stream, extracting a preview result from the video stream corresponding to the preview position, and transmitting the preview result while transmitting the video stream.

According to the above embodiments, a communications system for handling random seek of a preview position for streaming video comprises a receiving device and a transmitting device. The receiving device comprises a video processor for decoding an encoded video stream to generate a video signal, a network interface for sending a preview position, and for receiving the encoded video stream and a preview result corresponding to the preview position, and a display interface for controlling a display for displaying the preview result corresponding to the preview position while displaying the video signal. The transmitting device comprises a video processor for encoding a video stream to generate the encoded video stream, and for extracting the preview result corresponding to the preview position, and a network interface for transmitting the encoded video stream to the network interface of the receiving device, receiving the preview position from the network interface of the receiving device, and transmitting the preview result to the network interface of the receiving device while transmitting the encoded video stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a client interface for performing random seek of a preview position for streaming video.

FIG. 2 is a flowchart of a method of performing random seek of a preview position for streaming video according to a first embodiment.

FIG. 3 is a flowchart of a method of handling random seek of a preview position for streaming video according to a second embodiment.

FIG. 4 is a diagram of a communications system for handling random seek of a preview position for streaming video according to the embodiments.

### DETAILED DESCRIPTION

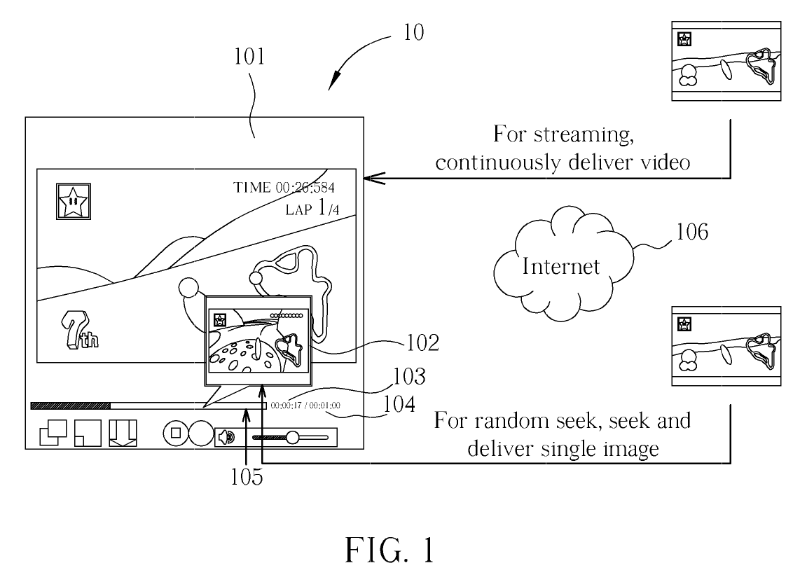

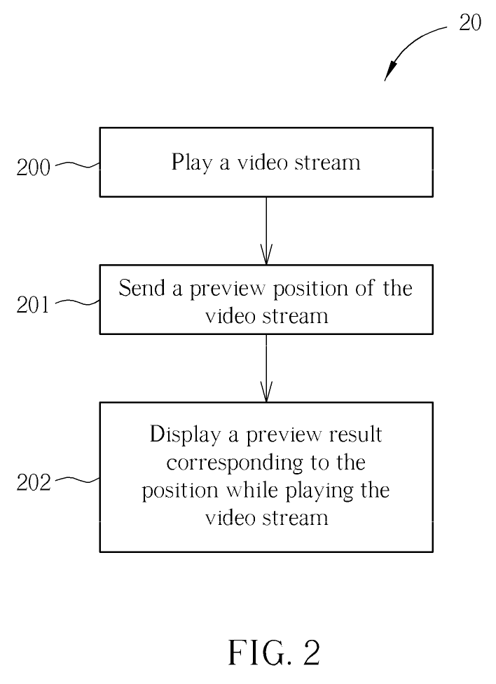

Please refer to FIG. 1, which is a diagram of a client interface 10 for performing random seek preview for streaming video. In conjunction with FIG. 1, please also refer to FIG. 2, which is a flowchart of a process 20 utilized for performing random seek of a preview position for streaming video according to a first embodiment. The process 20 may be realized as software code, or in hardware, e.g. in an ASIC or FPGA. In the client interface 10, a video stream may be played from a server (Step 200) in a main window 101. The main window 101 may be utilized for normal playback of the video stream. The client interface 10 includes a total length indicator 104, which shows total length of the video stream, for example one minute (as shown). The client interface 10 also includes a current position indicator 103, which shows a current playback position of the video stream. For example, in FIG. 1, the current position indicator 103 shows that 17 seconds of the video stream have been played back thus far. In addition, the client interface may include a time bar 105, which may communicate various information visually, such as the current playback position, and percent of the video stream already downloaded. The client interface 10 may be an object embedded in a webpage and displayable by a browser, such as a Flash object. The client interface 10 may also be part of a standalone application, such as media player software.

The video stream may be delivered over the Internet 106, and may also be a video stream in transit from a server. While the video stream is played, if a user desires to seek to a preview position of the video stream, the preview position of the video stream may be sent according to a request (Step 201). The user may click or drag on a time bar 105 of the client 10, and a preview result corresponding to the preview position may be displayed while playing the video stream (Step 202), for example in an overlay window 102. An input may be received from the user before sending the preview position of the video stream. The input is the preview position specified by the user. In one embodiment, the user may click on a position of the time bar 105, and the position may be converted into the preview position. In another embodiment, the user may hover the cursor over the position of the time bar, and the position may be converted into the preview position. The position may be used to obtain the preview position according to time, a ratio, or calculation. Then, the preview position of the video stream is sent to the server. The main window 101 may continue to play the video stream behind the overlay window 102. The preview result may be extracted from the video stream, corresponds to the preview position, and may be delivered over the Internet 106, as well. For example, the client may send the preview position to the server according to a request, the server may perform extraction of the preview result from the video stream corresponding to the preview position, and the preview result may then be received by the client from the server. Examples of the preview result include an image or an animated image, all of which may be sent over the Internet from the server. The animated image may comprise a sequence of 2D or 3D artwork or model positions, which may be displayed rapidly in sequence to create an illusion of motion. The animated image may be a motion picture or video program. Of course, many embodiments are possible. If the client has already received bits of the video stream corresponding to the preview position, the client may also perform extraction of the preview result locally. The server may also store pre-extracted images corresponding to fixed positions distributed evenly or randomly over the entire length of the video clip. In this case, the server may determine which of the pre-extracted images corresponds most closely to the preview position or according to distance of timestamp to determine the pre-extracted image, and send the pre-extracted image to the client to save processing time on the server side. In addition, the pre-extracted images could also be sent by default by the server while sending the video stream, such that the client can preload the pre-extracted images without having to wait for the server to process the request including the preview position.

In another embodiment, a section of video stream or an animated image may be received from the server corresponding to the preview position without influencing the transmitting video stream. In other words, the server may simultaneously transmit the video stream originally being transmitted and the section of video stream corresponding to the preview position. Then, in the overlay window 102, instead of displaying a static image, the section of video stream may be played starting from the preview position, while the video stream originally being transmitted may continue to be played back in the main window. Of course, the image or the animated image may also be generated locally if the client has already received the bits corresponding to the preview position from the server.

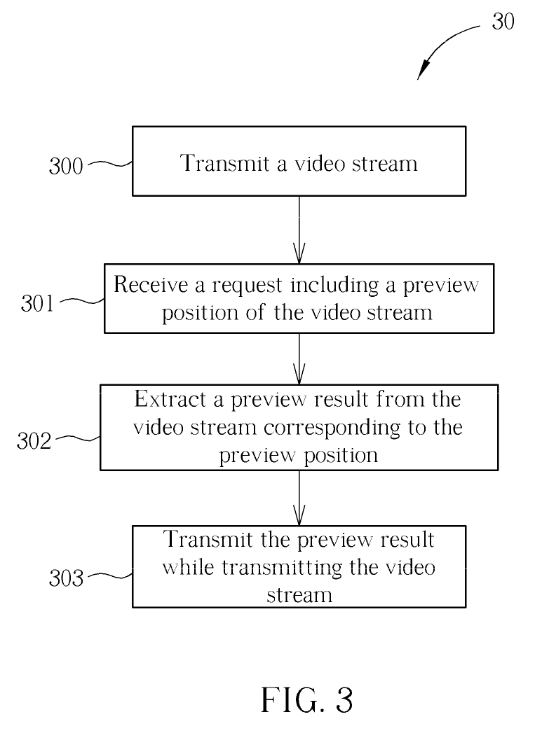

Please refer to FIG. 3, which is a flowchart of a process 30 for handling random seek of a preview position for streaming video according to a second embodiment. The process 30 may be realized as software code, or in hardware, e.g. in an ASIC or FPGA. From the server's perspective, the server may be transmitting the video stream to a client (Step 300). For example, the server may be transmitting the video stream over the Internet. While transmitting the video stream, the server receives a request from the client including the preview position of the video stream (Step 301). According to the preview position, the server may then extract a preview result from the video stream corresponding to the preview position (Step 302). Once the server has extracted the preview result, the server transmits the preview result to the client while continuing transmission of the video stream (Step 303). For example, the server transmits the preview result over the Internet while transmitting the video stream simultaneously. Of course, as described above, the server compares the preview position with a plurality of predefined positions or timestamp of pre-extracted image, and transmits the pre-extracted image corresponding to the predefined position nearest the preview position. The predefined positions may be frame numbers or timestamps defined in a number of different ways. For example, the frame numbers may correspond to beginnings of scenes, or the frame numbers may correspond to regular intervals, e.g. one predefined position every 900 frames (30 seconds for 30 fps video). The preview result may include an image or an animated image, all of which may be sent over the Internet.

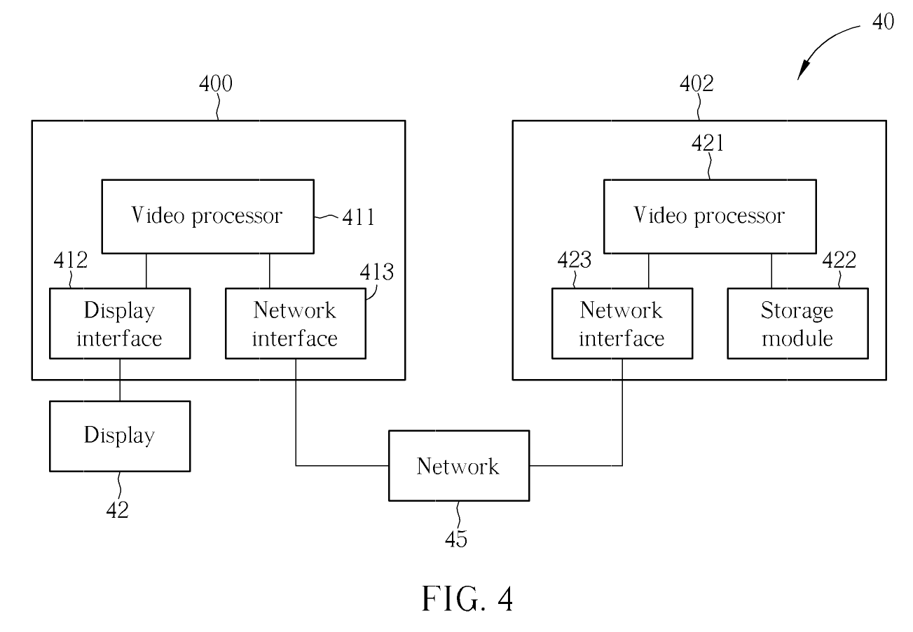

Please refer to FIG. 4, which is a diagram of a communications system 40 for handling random seek preview for streaming video according to the embodiments described above. The communications system 40 comprises a receiving device 400 and a transmitting device 402, which have a data connection established over a network 45. The receiving device 400 comprises a video processor 411, a network interface 413, and a display interface 412. The video processor 411 decodes an encoded video stream to generate a video signal. The network interface 413 may send the preview position to transmitting device 402 over network 45, and also may receive the encoded video stream and a preview result corresponding to the preview position from transmitting device 402 over network 45. The preview result may be an image or an animated image. The display interface 412 controls a display 42 for displaying the preview result corresponding to the preview position while displaying the video signal. Of course, the display 42 may be external to the receiving device 400, e.g. a monitor, or internally built into the receiving device 400, e.g. a display of a mobile phone.

The transmitting device 402 comprises a video processor 421 and a network interface 423. The video processor 421 encodes a video stream to generate the encoded video stream, and also extracts the preview result corresponding to the preview position. The transmitting device 402 further comprises a storage module 422 for storing the encoded video stream. The video processor 421 may be optional if the transmitting device 402 stores a previously encoded video stream in the storage module 422, and transmits over the network 45 using Hypertext Transfer Protocol. The network interface 423 transmits the encoded video stream or the previously encoded video stream to the network interface 413 of the receiving device 400 over the network 45. The network interface 423 may also receive the preview position from the network interface 413 of the receiving device 400 over the network 45, and transmit the preview result to the network interface 413 of the receiving device 400 over the network 45 while transmitting the encoded video stream.

Thus, the processes 20, 30 and the communications system 40 described above may be utilized for providing convenient seek and preview functionality to the user while playing back a video stream being downloaded, particularly through the Internet. This allows the user to get a quick idea of what is coming up without disrupting playback, and without having to buffer the video stream repeatedly every time the preview position is changed.

Those skilled in the art will readily observe that numerous modifications and alterations of the device and method may be made while retaining the teachings of the invention.

What is claimed is:

1. A method of performing random seek of a preview position for streaming video, the method comprising:
playing a video stream from a server;
sending the preview position of the video stream to the server; and
displaying a preview result corresponding to the preview position while playing the video stream in a client;
wherein the server extracts the preview result from the video stream corresponding to the preview position.

2. The method of claim 1, further comprising:
receiving an input by a user before sending the preview position of the video stream;
wherein the input is the preview position specified by the user.

3. The method of claim 1, further comprising:
providing a time bar showing time information of the video stream;
if the user clicks on a position of the time bar, converting the position to the preview position; and
sending the preview position of the video stream to the server.

4. The method of claim 1, further comprising:
providing the time bar showing time information of the video stream;
if the user hovers a cursor over a position of the time bar, converting the position to the preview position; and
sending the preview position of the video stream to the server.

5. The method of claim 1, further comprising:
receiving the preview result from the server over the Internet.

6. The method of claim 1, wherein the preview result is an image, or an animated image received from the server over the Internet.

7. The method of claim 1, wherein the preview result is displayed in an overlay window while playing the video stream in a main window behind the overlay window.

8. A method of providing random seek of a preview position for streaming video, the method comprising:
transmitting a video stream to a client;
receiving a request including the preview position of the video stream from the client;
extracting a preview result from the video stream corresponding to the preview position; and
transmitting the preview result to the client while transmitting the video stream.

9. The method of claim 8, wherein transmitting the preview result while transmitting the video stream comprises transmitting the preview result over the Internet while transmitting the video stream over the Internet.

10. The method of claim 8, wherein the preview result is an image or an animated image.

11. The method of claim 8, wherein extracting the preview result from the video stream corresponding to the preview position comprises comparing the preview position with a plurality of predefined positions or timestamp of pre-extracted image to determine the preview result.

12. A communications system for handling random seek of a preview position for streaming video, the communications system comprising:
a receiving device comprising:
a video processor for decoding an encoded video stream to generate a video signal;
a network interface for sending a preview position, and for receiving the encoded video stream and a preview result corresponding to the preview position; and
a display interface for controlling a display for displaying the preview result corresponding to the preview position while displaying the video signal; and
a transmitting device comprising:
a video processor for encoding a video stream to generate the encoded video stream, and for extracting the preview result corresponding to the preview position; and
a network interface for transmitting the encoded video stream to the network interface of the receiving device, receiving the preview position from the network interface of the receiving device, and transmitting the preview result to the network interface of the receiving device while transmitting the encoded video stream.

13. The communications system of claim 12, wherein the transmitting device further comprises a storage module for storing the encoded video stream.

14. The communications system of claim 12, wherein the preview result is an image or an animated image.
